(19) United States
(12) Patent Application Publication
(10) Pub. No.: US 2019/0219981 A1
(43) Pub. Date: Jul. 18, 2019

(54) METHOD AND SYSTEM FOR ANOMALY DETECTION IN A MANUFACTURING SYSTEM

(71) Applicant: SIEMENS AKTIENGESELLSCHAFT, München (DE)

(72) Inventors: Raffaello Lepratti, Genua (IT); Steffen Lamparter, Feldkirchen (DE); Martin Ringsquandl, Traunstein (DE)

(21) Appl. No.: 16/328,908

(22) PCT Filed: Sep. 29, 2016
(86) PCT No.: PCT/EP2016/073324

§ 371 Date: Feb. 27, 2019

(30) Foreign Application Priority Data
Aug. 29, 2016 (EP) 16186116.6

(51) Int. Cl. G05B 19/05; G05B 13/02

(52) U.S. Cl. CPC G05B 19/058; G05B 2219/14006; G05B 13/0265

(57) ABSTRACT

In a monitoring phase, live instance vectors including data from all devices of a manufacturing system are acquired. A constraint-based clustering algorithm assigns each live instance vector to a cluster, thereby forming a live sequence of clusters. The live sequence is classified based on at least one behavior model. An anomaly is detected depending on the classification result. Each cluster represents a state of the manufacturing system. The sequences of clusters can be generated by consecutive operations that are performed in the manufacturing system. The constraint-based clustering algorithm facilitates an unsupervised (automated) or semi-supervised learning of system behavior that may be supplemented with supervised or unsupervised learning of the behavior models. The method provides a way of automated learning of discrete event dynamic systems from data generated by sensors and actuators without requiring manual input.

This application claims priority to PCT Application No. PCT/US2016/073324, having a filing date of Sep. 29, 2016, based off of European Application No. 16186116.6, having a filing date of Aug. 29, 2016, the entire contents both of which are hereby incorporated by reference.

### FIELD OF TECHNOLOGY

Today's data-driven process & quality monitoring approaches, e.g. SPC (statistical process control) or SQC (statistical quality control) usually require in-depth domain knowledge and high manual engineering effort which leads to highly static monitoring systems.

### BACKGROUND

Today, the detection of abnormal behavior for large-scale industrial automation systems (e.g. multi-stage manufacturing systems controlled by several PLCs) is a challenging task. In current systems and Automation, SCADA, and MES products such monitoring functions are manually implemented based on known dependency via alarms and warnings (on each automation level). If the underlying system changes the monitoring systems have to be manually adapted. More sophisticated approaches like common statistical quality and process control (SQC, SPC) applications are a first step towards automating the generation of monitoring models by leveraging statistical, data-driven methods.

However, traditional SPC and SQC methods still have to be manually designed and configured based on in-depth domain expert know-how.

Known methods for anomaly detection in industrial plants include model-based and statistical approaches. Model-based approaches are usually resting upon simulation models (e.g. Matlab Simulink, PlantSimulation, etc.) created by domain experts who replicate an approximated model of the physical behavior of the underlying system.

Data-driven approaches try to detect anomalies, however these are usually deployed locally to monitor and predict behavior of single devices (e.g. common Statistical Quality and Process Control Charts, dedicated Neural Networks). These methods cannot be used for large-scale automation systems, where the interconnections between different devices and operations need to be considered.

For example, dedicated Neural Networks can be used for anomaly detection in single gas turbines. These networks need to be trained with supervision on huge amounts of labeled data. Plus, due to the networks black box functioning, for a detected incident it remains unknown which combination of values from different components caused it.

### SUMMARY

According to the method for anomaly detection in a manufacturing system, one or more processors execute the following steps during a monitoring phase. Live instance vectors comprising data from at least some, and in particular all, devices of the manufacturing system, are acquired. A constraint-based clustering algorithm assigns each live instance vector to a cluster, thereby forming a live sequence of clusters. The live sequence is classified based on at least one behavior model. An anomaly in the manufacturing system is detected depending on the classification result.

The system for anomaly detection in a manufacturing system comprises an interface, configured to receive live instance vectors comprising data from at least some, and in particular all, devices of the manufacturing system. It has a memory, containing a clustering model and a sequence classifier. Furthermore, it is equipped with a processor, programmed for executing a constraint-based clustering algorithm to assign each live instance vector to a cluster of the clustering model, thereby forming a live sequence of clusters, classifying the live sequence using the sequence classifier, and detecting an anomaly in the manufacturing system depending on the classification result.

The clustering model may contain a mathematical description of the clusters. The sequence classifier may contain a behavior model and a threshold that is used for classification.

Each cluster represents a state of the manufacturing system. The sequences of clusters can be generated by consecutive operations that are performed in the manufacturing system.

By capturing sequence violations, it is possible to detect anomalies that are caused by correlations or dependencies at a global, even facility-wide, range. If the time series datasets are collected for all devices and subsystems of the manufacturing system, then the sequences represent sequences of states of the whole plant. This provides a holistic scope of data analysis for anomaly detection with the option to consider every measurement generated by the manufacturing system. At least one embodiment collects integrated operational data from all devices and subsystems into a distributed data processing system.

The method facilitates classification and deployment, because clustering simplifies the classification task of high-dimensional multivariate time series data. Prior knowledge and user-defined constraints can be incorporated into the analysis. At least one embodiment has a computationally inexpensive model that is suited for different deployment architectures and enables processing in near real-time.

At least one embodiment provides a flexible monitoring system that automatically adapts to changing conditions, instead of using statically defined rules.

At least one embodiment provides new possibilities of applying abnormal behavior detection and root-cause-analysis over a complete plant with timely dependencies.

At least one embodiment improves results of analysis, i.e. predictions, interpretable insights (cluster profiles), via additional control and domain-specific knowledge.

At least one embodiment is applied in near real-time and ensures possibilities to react quickly.

According to an embodiment of the method, the following steps are executed by one or more processors in a preparation phase prior to the monitoring phase. Several time series datasets are acquired from at least some, and in particular all, devices of the manufacturing system, with each time series dataset consisting of a number of instance vectors. Then, the constraint-based clustering algorithm assigns each instance vector of each time series dataset to a cluster, thereby forming a sequence of clusters for each time series dataset. A learning algorithm builds the at least one behavior model for the manufacturing system by analyzing the sequences.

The time series datasets are generated over a certain time period, e.g. a production sequence, for example a production cycle of a batch or lot.

The embodiment facilitates an unsupervised (automated) or semi-supervised learning of system behavior with the constraint-based clustering algorithm that may be supplemented with supervised or unsupervised learning of the behavior models. The domain constraints of the clustering algorithm can be derived from alarm definitions and other sources. At least one embodiment guides clustering via user-defined and system-inherent domain constraints.

The embodiment provides a way of automated learning of discrete event dynamic systems from data generated by sensors and actuators without requiring manual input. A Discrete event dynamic system (DEDS) is a event-driven, discrete-state system of which the state evolution depends completely on the occurrence of asynchronous discrete events over time. It consists solely of event-driven state transition mechanism and discrete state spaces. It can be modeled using the Discrete Event System Specification (DEVS) formalism or the Finite & Deterministic Discrete Event System Specification (FD-DEVS) formalism, for example.

According to an embodiment of the method, the learning algorithm builds a behavior model for each operation performed by the manufacturing system.

According to an embodiment of the method, each time series dataset has a label, in particular a product state that was the result of a production cycle that is represented by the respective time series dataset. A cannot-link constraint (CL) is created for a pair of instance vectors if they share the same time step and their respective time series datasets have different labels.

A mathematical description of this embodiment is given in Definition 2 and Example 2 below. This embodiment allows putting prior domain knowledge into the system. By considering product state already in the clustering phase and distinguishing bad quality cluster sequences from good ones, the influence of clusters on product quality can be assessed. In this way, product quality information can be seamlessly integrated into the method to guide its unsupervised learning.

According to an embodiment of the method, at least one of the behavior models is linked to at least one product state, in particular by mapping different clusters inside the behavior model to different product states. The live sequence is classified based on the at least one behavior model with respect to a product state.

According to this embodiment, the behavior models allow to classify the product state that the live sequence is going to result in.

According to an embodiment of the method, a behavior model for each operation performed by the manufacturing system is used. Each behavior model (BMA, BMB) contains one or more clusters.

According to an embodiment of the method, each of the at least one behavior models is a probabilistic finite-state automaton for which each cluster is considered as a state. An anomaly is detected if the probability for at least one cluster transition in the live sequence is below a learned or user-defined threshold in the respective behavior model.

If the learning algorithm is supervised and uses labeled data, then the threshold can be learned by the algorithm. If the learning algorithm is un-supervised, then the threshold is defined by the user.

According to an embodiment of the method, the constraint-based clustering algorithm uses must-link constraints and/or cannot-link constraints.

According to an embodiment of the method, the must-link constraints and/or cannot-link constraints are derived from control knowledge about the manufacturing system prior to the monitoring phase.

This embodiment reduces engineering effort for SPC/SQC applications by automated building of statistical models based on data and domain constraints, i.e. control knowledge.

For example, an engineer can specify that two power measurements must be separated in two different clusters if they are not in a given interval. This would then result in a cannot-link constraint on instance vectors such that they do not appear in the same cluster.

According to an embodiment of the method, prior to the monitoring phase must-link constraints and/or cannot-link constraints are extracted from specifications of function blocks of the manufacturing system, in particular from input variables and/or output variables of function blocks in control code of PLCs.

In this way, control knowledge and function blocks are used to guide the event categorization to ensure meaningful clusters without having labels attached to data (unsupervised learning).

For an example of this embodiment of extracting cluster definitions as constraints, see Definition 1 and Example 1 below.

According to an embodiment of the method, an emergency action is triggered if an anomaly in the manufacturing system is detected.

This embodiment prevents “out-of-control”-behavior through triggering of emergency actions, if the live sequence violates function block constraints, for example.

According to an embodiment of the method, constraints are propagated inside equipment hierarchies prior to the monitoring phase.

This embodiment allows for local constraint propagation of locally-sensitive variables (e.g. similar intervals of power and voltage need also to follow given constraints). It is advantageous for large-scale automation systems, where the interconnections between different devices need to be considered. Equipment hierarchies are used to generalize device-specific constraints and apply them throughout the system. For an example of an implementation, see Definition 3.

According to an embodiment of the method, the manufacturing system is a multi-operation manufacturing system.

This embodiment is suitable for large-scale automation systems, where the interconnections between different devices and operations need to be considered.

According to an embodiment of the system, the interface is configured to receive function block constraints. The constraint-based clustering algorithm is configured to use the function block constraints. The system triggers an emergency action by generating an output when detecting the anomaly.

According to an embodiment of the system, the function block constraints are must-link constraints and/or cannot-link constraints.

According to an embodiment of the system, the function block constraints have been extracted from specifications of function blocks of the manufacturing system, in particular from input variables and/or output variables of function blocks in control code of PLCs.

According to an embodiment of the system, the sequence classifier contains a behavior model for each operation performed by the manufacturing system.

According to an embodiment of the system, each behavior model is a probabilistic finite-state automaton for which each cluster is considered as a state. An anomaly is detected if the probability for at least one cluster transition in the live sequence is below a learned or user-defined threshold in the respective behavior model.

Further embodiments allow application of the method and system on all automation levels (PLC, SCADA, MOM, cross-plant).

According to an embodiment of the system, it is distributed over several data processing systems.

According to an embodiment of the system, it is deployed in a cloud.

This embodiment can be implemented using a common distributed data-processing framework, for example Apache Hadoop or Spark.

According to an embodiment of the system, it is embedded in a controller.

This embodiment can be implemented by using a programming API of an embedded controller, such as the S7-1500.

According to an embodiment of the system, it is deployed in a manufacturing execution system.

This embodiment can be implemented by using application development environments of common manufacturing execution systems such as Simatic IT.

The computer-readable storage media stores instructions executable by one or more processors of a computer system, wherein execution of the instructions causes the computer system to perform the method.

The computer program is executed by one or more processors of a computer system and performs the method.

### BRIEF DESCRIPTION

Some of the embodiments will be described in detail, with reference to the following figures, wherein like designations denote like members, wherein:

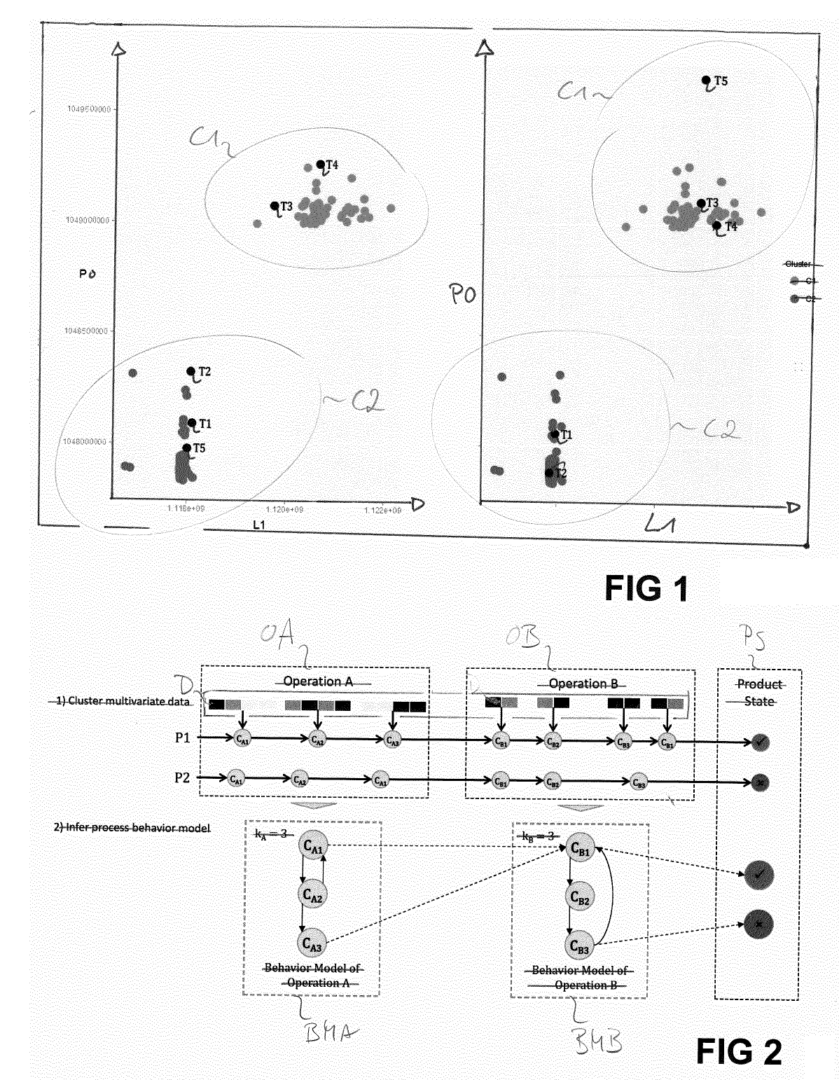

FIG. 1 depicts two-dimensional time series data in two clusters;

FIG. 2 is a schematic overview of how sequences are generated by two consecutive operations and used for building behavior models;

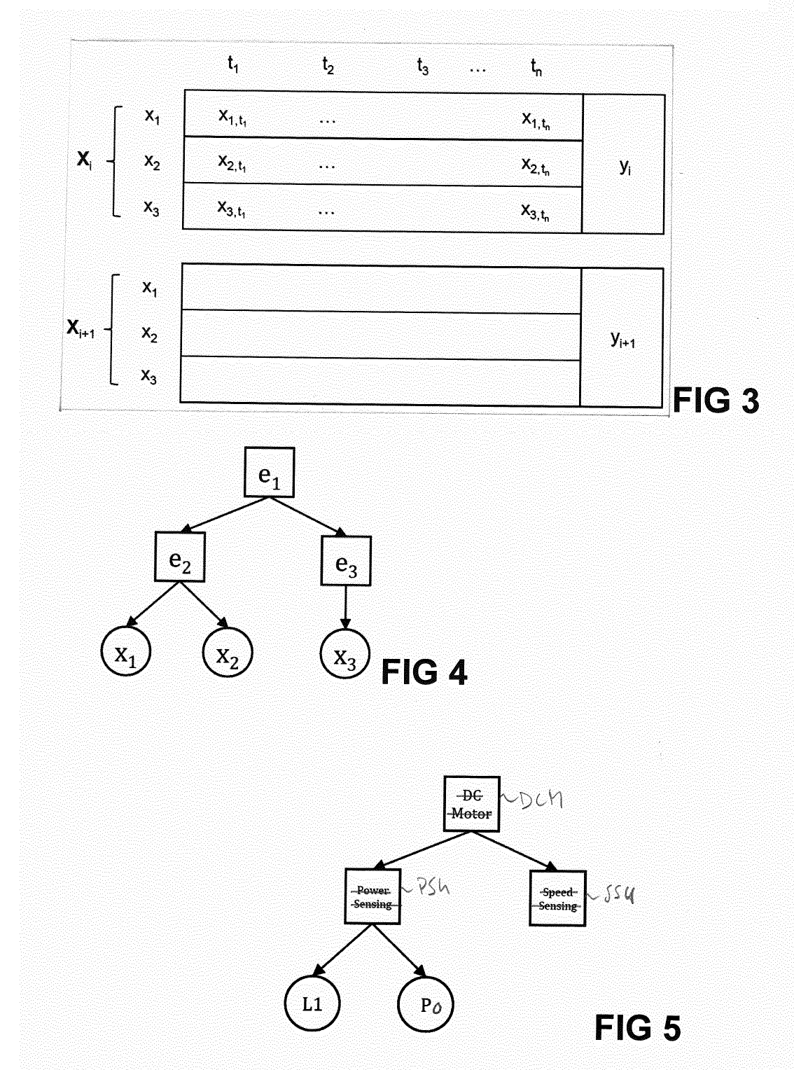

FIG. 3 depicts two labeled time series datasets;

FIG. 4 is an equipment hierarchy model;

FIG. 5 is a hierarchy of an electric motor;

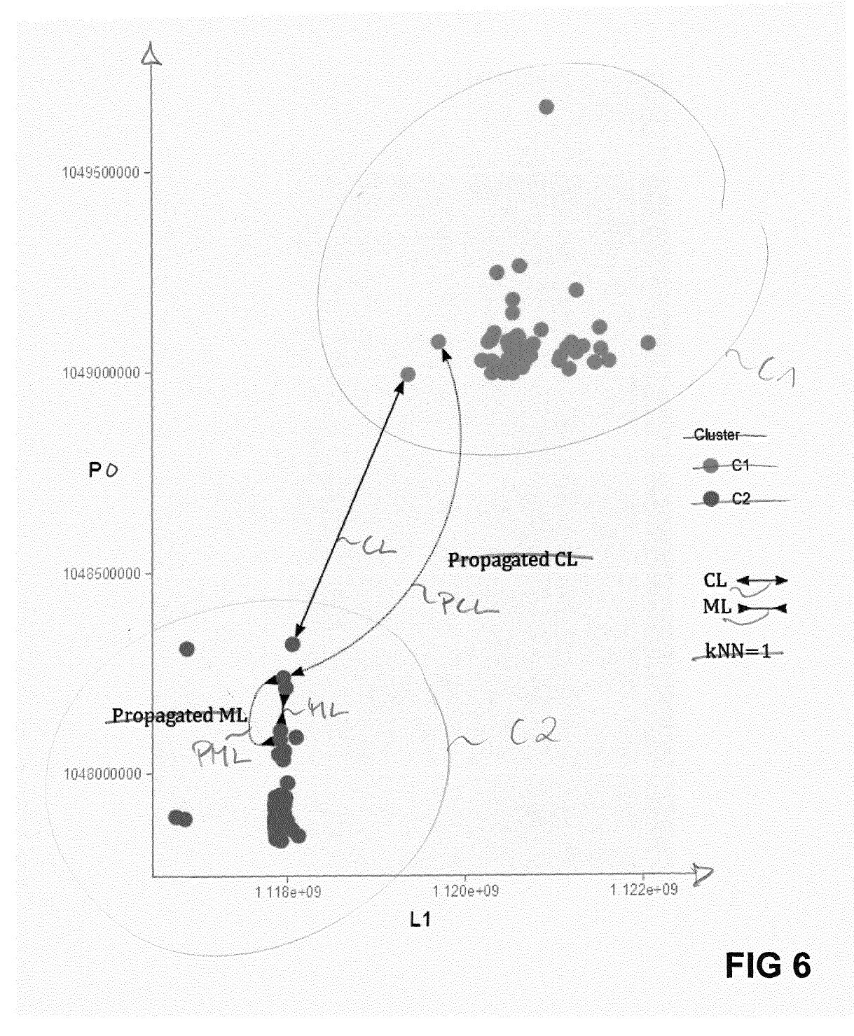

FIG. 6 is an equipment-induced subspace with propagated Must-Link and Cannot-Link constraints;

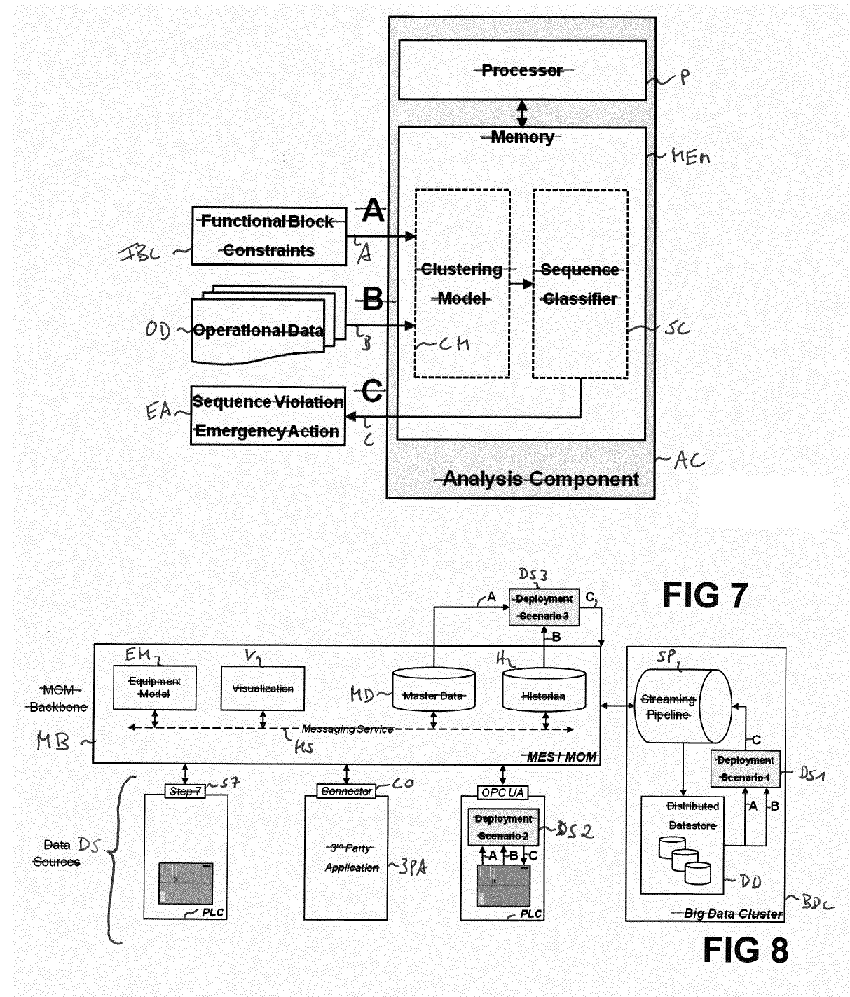

FIG. 7 depicts a system for anomaly detection;

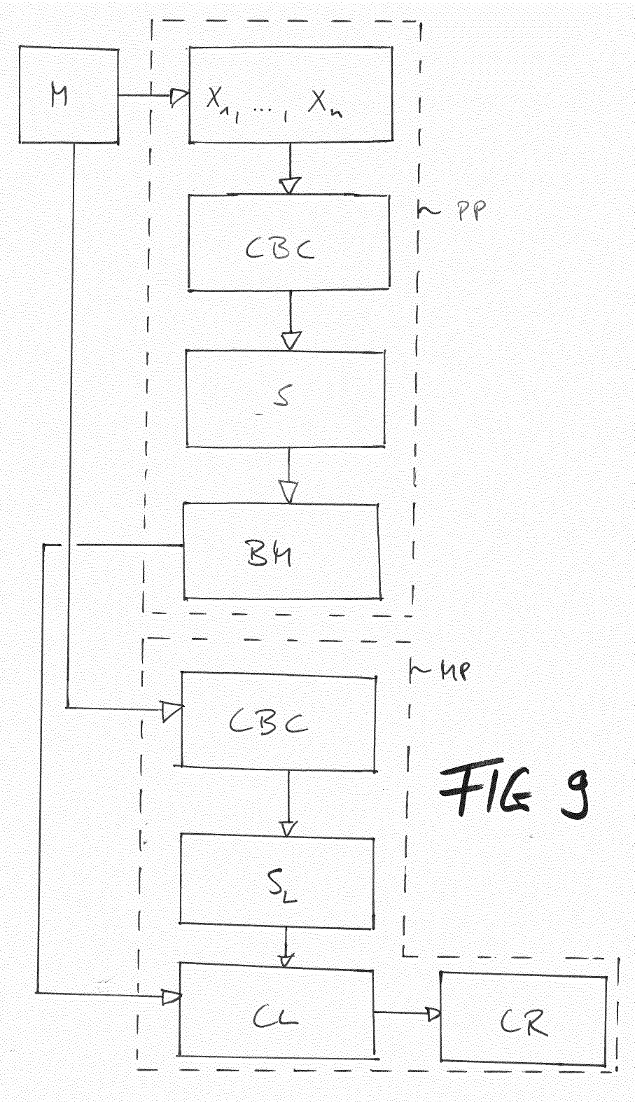

FIG. 8 depicts several deployment scenarios for the system; and

FIG. 9 is a flowchart showing anomaly detection in a manufacturing system.

### DETAILED DESCRIPTION

The following embodiment describes the monitoring of an electric motor that observes power and voltage measurements. FIG. 1 shows two cases of two-dimensional time series datasets in two clusters as an example of the data collected over some time. Here, the measurements of power PO and voltage L1 form a first cluster C1 and a second cluster C2.

On the left-hand side of FIG. 1, a normal sequence of operation from time step T1 to time step T5 is displayed. The clustering sequence is [C2, C2, C1, C1, C2]. On the right hand side, the cluster sequence is [C2, C2, C1, C1, C1], where time step T5 is also clearly an outlier. Capturing sequence violations like this is not possible with common detection approaches, as they ignore the dependencies over time. However, observing the sequences of cluster assignments, time-dependent behavior abnormalities can be detected.

The next embodiment applies this idea to the learning of system behavior from data generated by at least some, and in particular all, devices of a manufacturing system, e.g. by the complete plant equipment, over a certain period of time. This means the embodiment operates on high-dimensional multivariate time series data, which is quite challenging for common data processing systems. The time period is usually a production sequence, e.g. a production cycle of a batch or lot.

Let D={(X₁, y₁), . . . (X_{N}, y_{N})} be a set of N time series datasets

$${X}_{s} = \{ ( {x}_{{t}_{1}}^{1} , … {x}_{{t}_{1}}^{m} ) , … ( {x}_{{t}_{{n}_{s}}}^{1} , … {x}_{{t}_{{n}_{s}}}^{m} ) \} ,$$

such that each time series has nₛ instance vectors xₜ_{ᵢ}∈ [symbol] ^{m} of dimensionality m.

The anomaly detection according to this embodiment consists of three steps, where steps 1 and 2 are responsible for model building and step 3 is concerned with the actual detection:

1. Clustering: Obtaining sequences S by constraint-based clustering of X

2. Behavior Model Inference: Obtaining a classifier for a given sequence S by building a behavior model.

3. Assessment: Processing a stream of live instance vectors, assessing state transition probabilities and classification of y if one or more state transitions in one of the behavior models are below a learned threshold.

Step 1 at first needs an unsupervised training phase to obtain sequences of clusters, each cluster being a model of a state of the manufacturing system. Step 1 executes a constraint-based clustering algorithm to assign each instance vector xₜ_{ᵢ} of each time series dataset (X₁, . . . , X_{N}) to a cluster, thereby forming a sequence S of clusters for each time series dataset (X₁, . . . , X_{N}).

During live-monitoring (step 3), the same constraint-based clustering algorithm can be used for assignment of live instance vectors (the new incoming data) to clusters in a streaming fashion.

Step 2 includes training of the behavior models, which can be implemented as probabilistic finite-state automata with probabilistic state transitions. These probabilities as well as a threshold for classification need to be learned in a supervised manner. This is done by executing a learning algorithm to build at least one behavior model for the manufacturing system by analyzing the sequences S.

In step 3 a live-monitoring system acquires live instance vectors comprising data from at least some, and in particular all, devices of the manufacturing system. The live-monitoring system executes the constraint-based clustering algorithm to assign each live instance vector to a cluster, thereby forming a live sequence of clusters. It classifies the live sequence based on the at least one behavior model, and detects an anomaly in the manufacturing system depending on the classification result.

A possible implementation of the classification part of step 3 is to assess the probabilities of cluster transitions (i.e. the probability of one cluster following the other in the growing live sequence) as specified in the behavior models. To this end, the behavior models can be implemented as probabilistic finite-state automata that are built and learned for each operation performed by the manufacturing system. Anomalies are detected if at least one state transition falls below a user-defined threshold in the respective behavior model, with the state transition in the behavior model representing the cluster transition in the live sequence.

Steps 1 and 2 are performed before-hand and can be seen as a form of process mining. Step 3 is the live-monitoring of the manufacturing system and can be seen as a form of process monitoring. The behavior models do not need to be analyzed in detail; they mainly serve as a basis to detect conspicuous state changes that indicate an anomaly.

Clustering as a pre-processing step is especially suitable in this domain, because it allows the integration of constraints and improves the interpretability of results.

Behavior Models

It is assumed that state transitions of the manufacturing system as stored in the sequences S are desired in the majority of the cases. For example, a motor goes from state running to stopping if a light barrier is triggered. Then undesired state transitions should occur with low probability.

The behavior model can be implemented as an automaton (finite-state machine), which has probabilistic state transitions. The probabilities of state changes can be inferred from the sequences S with known stochastic automata induction algorithms that use state merging and prefix trees [2]. This can be efficiently implemented for example in a programming language like C or C++.

An anomaly is detected if a cluster transition occurs in the live sequence for which probability of the respective state transition that is stored in the behavior model falls below a learned or user-defined threshold. It is also possible to consider several consecutive cluster transitions and to sum up their probabilities in the behavior model for classification.

FIG. 2 shows a schematic overview of how sequences are generated by two consecutive operations (a first operation OA and a second operation OB) and later used for building behavior models. The upper part of FIG. 2 shows the previously described step 1. During a first production cycle P1, a time series dataset D is acquired from devices of the manufacturing system, consisting of a number of instance vectors during a first operation OA and a consecutive second operation OB. A constraint-based clustering algorithm assigns each instance vector of D to one of the clusters C_{A1}, C_{A2}, C_{A3}, C_{B1}, C_{B2}, C_{B3}, thereby forming a sequence of clusters for the time series dataset D which leads to a product state PS that is good. The same is done for a second time series dataset that is obtained during a second production cycle P2, leading to a product state PS that is bad.

The lower part of FIG. 2 shows the previously described step 2. Here a behavior model of the first operation BMA and a behavior model of the second operation BMB are inferred from the two sequences. In the particular embodiment shown in FIG. 2, the behavior models are connected to a good and bad product state PS. Therefore, they can be used a classifier for a given sequence regarding whether that sequence leads to a good or bad product state. In FIG. 2, both behavior models are formed with three clusters. Note that there is a state transition from one behavior model to the other. The behavior models can be implemented as an automaton (finite-state machine), for example as a probabilistic finite-state automaton which has probabilistic state transitions.

Based on the behavior models of FIG. 2, a live sequence of clusters originating from current data can be classified with regard to product state. For example, if the first operation OA finishes with cluster C_{A1} and/or the second operation OB finishes with cluster C_{B3}, it can be inferred from the behavior models that the live sequence will lead to a product state PS that is bad, and therefore, an anomaly can be detected.

If cluster transitions are represented with probabilities in the behavior models, then a threshold for anomaly detection can be learned as well.

The previous example as depicted in FIG. 2 connects both the sequences from the first production cycle 1 and the second production cycle 2 as well as the behavior models with a product state PS, and uses this information for classification. This is a form of supervised learning as it needs labeled training data.

An alternative approach consists of analyzing a large number of sequences obtained during a mostly normal or healthy mode of operation of the manufacturing system. Then, undesired state transitions should occur with low probability in the training data.

Here, the behavior models can be implemented as probabilistic finite-state automata with a data driven and unsupervised learning method, with their probabilistic state transitions reflecting the large body of training data obtained during a mostly normal or healthy mode of operation. In this embodiment, an anomaly can be detected if the probability for at least one cluster transition in the live sequence is below a user-defined threshold in the respective behavior model.

FIG. 3 shows a set D={(Xᵢ, yᵢ), (Xᵢ₊ᵢ, y₁₊₁)} of two time series datasets Xᵢ={(xₜ_{₁}¹, xₜ_{₁}², xₜ_{₁}³), . . . (xₜ_{ₙ}, xₜ_{ₙ}², xₜ_{ₙ}³)}, such that each time series dataset has n instance vectors xₜ_{ᵢ}∈ [symbol] ³ of dimensionality 3. Each time series dataset Xᵢ, Xᵢ₊₁ is labeled with a label yᵢ, yⱼ₊ᵢ, for example indicating the product state or quality that was the result of the production cycle corresponding to the respective time series dataset Xᵢ, Xᵢ₊₁.

FIG. 4 shows an equipment tree with three nodes e₁, e₂, and e₃. At each time step, the node e₂ provides sensor measurements x₁ and x₂ and the node e₃ the sensor measurement x₃. Those three sensor measurements x₁, x₂, x₃ form the components of the instance vectors xₜ_{ᵢ} ∈ [symbol] ³ depicted in FIG. 3.

FIG. 5 shows a more specific example of an equipment tree, a hierarchy of an electric motor. The DC Motor DCM consists of a power sensing unit PSU and a speed sensing unit SSU. The power sensing unit PSU measures power PO and voltage L1 as depicted in FIG. 1.

Introducing Domain Constraints for Clustering

According to embodiments of the method and system, domain knowledge that can be used as constraints falls into the following categories:
Variable dependencies: Known connections between values of multiple variables
Variable grouping: Groups of variables that generate data are interconnected, often in a hierarchical order
Sequence boundaries: Knowledge about separation between end time of one sequence and start of the next one

Sequence boundaries can usually be determined by the cycle times of operations of the manufacturing system.

In the clustering phase, embodiments of the method and system incorporate knowledge about known behavior of the system that is to be treated equally or to be distinguished. This is done by constraining pairs of instances for which must-link [symbol] [symbol] and cannot-link constraints [symbol] [symbol] hold. Technically, the task boils down to finding an assignment L={lᵢ}ᵢ₌₁ⁿ of all instances into K non-overlapping clusters that simultaneously minimizes an objective function and violates as few constraints as possible.

In many applications, there are known dependencies between variables in the time series. For industrial automation systems, there are usually models of control programs and equipment hierarchies that can be used.

Variable Dependency Constraints

In the present embodiment, a must-link constraint on variables can be expressed as a formula in propositional logic over binary variables.

### Definition 1 (Binary Variable Must-Link)

A formula in propositional logic [symbol] enforces a must-link constraint between a pair of instances, written [symbol] [symbol] (xₜ_{ᵢ},xₜ_{ⱼ}), iff ϕ(xₜ_{ᵢ}) [symbol] [symbol] ∧ϕ(xₜ_{ⱼ}) [symbol] [symbol] , where ϕ(x) maps an instance to its binary variable representation.

### Example 1

The present embodiment considers inputs to programs of industrial controllers in propositional logic, e.g. [symbol] =LightBarrier ∧¬MotorRunning. The must-link constraint would hold for every time step in which a light barrier was triggered and a motor was not running.

Function blocks are known from the Function Block Diagram (FBD), a graphical language for programmable logic controller design. A function block describes the function between input variables and output variables. Function Block Diagram is a language for logic or control configuration supported by the standard IEC 61131-3 for a control system such as a Programmable Logic Controller (PLC) or a Distributed Control System (DCS).

Function blocks can be used as control knowledge to guide the event categorization. In this context, event categorization is simply the execution of the constraint-based clustering, with each cluster yielding a model of a state of the manufacturing system. The system is able to interpret function blocks of controllers such that input and output variables of function blocks represent clusters of their own. For example, the control output (O₁) of a conveyor might be triggered by two light barriers (I₁, I₂), such that the logical formula of function block ( [symbol] ) in linear temporal logic looks like:

[symbol]

[symbol]

I₁ ∧I₂ and [symbol] [symbol] ₓO₁.

This means, the function block must satisfy that if both light barriers are on, then the output must also be on in the next (x) time step. The clustering puts all time series points that satisfy the input condition in one cluster (e.g. “light barriers on”-cluster) and the same for all points that satisfy the output condition (e.g. “motor on”-cluster). State sequence violations of resulting from such constraints could directly be used to flag an alarm or an emergency action, because the control system seems to be broken.

Such cluster (i.e. state) definitions can be extracted as constraints from input variables of the function blocks in the control code of the PLCs.

This kind of semi-supervised clustering in the first phase facilitates the learning of the behavior models by using domain knowledge of the form of the Must-Link (ML) and Cannot-Link (CL) constraints. These constraints ensure a more clear distinction between normal and abnormal behavior.

FIG. 6 shows a Must-Link Constraint ML and a Cannot-Link Constraint CL in the time series dataset previously presented on the right side of FIG. 1, consisting of a first cluster C1 and a second cluster C2.

For example, an engineer can specify that two power measurements must be separated in two different states if they are not in a given interval. This would than result in a cannot-link constraint on all time series instances such that they do not appear in the same state (cluster).

Sequence Constraints

Viewing clustering as pre-processing step for sequence classification, it is beneficial to leverage available labeled sequences already during the clustering stage. Considering product state already in the clustering phase (i.e. distinguishing bad quality sequences from good ones) provides an opportunity to put prior domain knowledge into the system.

### Definition 2 (Sequence Cannot-Link)

A pair of instances (xₜ_{ᵢ}, xₜ_{ⱼ}) appear in a cannot-link constraint [symbol] [symbol] if they share the same time step and their respective sequences have different labels, formally

[symbol]

[symbol]

(xₜ_{ᵢ},xₜ_{ⱼ})={(xₜ_{ᵢ},xₜ_{ⱼ})|xₜ_{ᵢ}∈Xₛ,xₜ_{ⱼ}∈X_{s′}:yₛ≠y_{s′}∧i=j,s,s′∈(1, . . . ,N},i,j∈{1, . . . ,nₛ)}

### Example 2

In a production system, labeled sequences could be obtained by looking at final product quality, e.g. (Xᵢ, yᵢ=“accept”) (Xᵢ₊₁,yᵢ₊₁=“reject”).

Here, clusters would be penalized for pairs of instances that belong to sequences with different quality labels. This step is not necessary, in case product states are unknown. However, including such knowledge about product states produces a more robust clustering model that can better distinguish between desired and undesired states, since sequences with the label “reject” are more likely to contain undesired states.

Constraint Propagation

Depending on the amount of domain knowledge, the transitive closure of constraints might result in a fair amount of constrained pairs. However, it can be helpful to further leverage knowledge about equipment hierarchies in the automation system.

First of all, an equipment hierarchy allows to separate all variables into equipment-induced subspaces of the original dataset. Formally, let G= [symbol] V, E [symbol] be a directed rooted tree, where every leaf node represents exactly one variable xⁱ of the input space [symbol] ^{m}.

### Definition 3 (Equipment-induced Subspace)

Given equipment hierarchy model G and some node N∈V, a subspace S⊂ [symbol] ^{m} is defined by S={xⁱ|xⁱ ∈descendants (N)}.

FIG. 5 shows a hierarchy of an electric motor and FIG. 6 shows an equipment-induced subspace for the electric motor. Power PO measurements are plotted against voltage L1.

The equipment-induced subspace S allows to propagate ML and CL constraints in the following way:

∀xₜ_{_{z}}∈NN_{S}(xₜ_{ⱼ}): [symbol] [symbol] (xₜ_{ᵢ},xₜ_{ⱼ})→ [symbol] [symbol] (xₜ_{ᵢ},xₜ_{_{z}})

∀xₜ_{_{z}}∈NN_{S}(xₜ_{ⱼ}): [symbol] [symbol] (xₜ_{ᵢ},xₜ_{ⱼ})→ [symbol] [symbol] (xₜ_{ᵢ},xₜ_{_{z}})

Where NN_{S}(xₜ_{ⱼ}) are the k (e.g. 3) nearest-neighbors of xₜ_{ⱼ} in subspace S. This is the propagate-constraints algorithm.

This means that ML and CL constraints are propagated to other instances if they are close to each other in the equipment induced subspace. A propagated Cannot-Link constraint PCL and a propagated Must-Link constraint PML are also shown in FIG. 6. In this way, constraints can be propagated inside equipment hierarchies for locally-sensitive variables. For example, similar intervals of power and voltage need also to follow given constraints.

Expectation-Maximization Algorithm

The well-known Expectation-Maximization (EM) algorithm can be used to incorporate the previously presented constraints.

For algorithmic realization of the domain-constraint clustering task, the present embodiment relies on the probabilistic framework for penalized clustering [1]. The objective function is defined as:

$${J}_{obj} = D ( {x}_{{t}_{i}} , {μ}_{h} ) + {\sum }_{( {x}_{{t}_{i}} , {x}_{{t}_{j}} ) ∈ ℳℒ} D ( {x}_{{t}_{i}} , {x}_{{t}_{j}} ) I [ {l}_{i} \neq {l}_{j} ] + {\sum }_{( {x}_{{t}_{i}} , {x}_{{t}_{j}} ) ∈ 𝒞ℒ} ( {D}_{ma x} - D ( {x}_{{t}_{i}} , {x}_{{t}_{j}} ) ) I [ {l}_{i} = {l}_{j} ]$$

where D is some divergence function and I is the identity function. It can be seen that violation of must-link constraints is heavier penalized by growing distance and violation of cannot-link constraints by closeness.

Algorithm 1 Domain-constraint Clustering

Input: Sequences (Xᵢ, yᵢ), equipment model G, constraint sets [symbol] [symbol] and [symbol] [symbol] , number of clusters K

Output: cluster centers μₖ, k=1 . . . K
propagate-constraints (G, [symbol] [symbol] , [symbol] [symbol] )
init-centers( )
while not converged do

for xₜ_{ⱼ}∈X do

$$\begin{matrix}{l}_{j} = arg {min}_{{μ}_{k}} {J}_{obj} ( {x}_{{t}_{j}} , {μ}_{k} ) & \to expectation step \\ {μ}_{k} = \frac{{\sum }_{{l}_{j} = k} {x}_{{t}_{j}}}{\vert {l}_{j} = k \vert} & \to maximization step\end{matrix}$$

end for

end while
return {μₖ}ₖ₌₁^{K}

FIG. 7 shows an analysis component AC as an embodiment of a system for anomaly detection. The analysis component AC has a processor P and a memory MEM. The memory MEM stores a clustering model CM and a sequence classifier SC. The clustering model CM and the sequence classifier SC have been built beforehand in a preparation phase and are now stored in the memory MEM. The analysis component AC receives operational data OD as a second input B. The operational data OD contain live instance vectors comprising data from at least some, and in particular all, devices of a manufacturing system. The processor P uses the clustering model CM for executing a constraint-based clustering algorithm to assign each live instance vector to a cluster, thereby forming a live sequence of clusters. The processor P classifies the live sequence based on at least one behavior model that is contained in the sequence classifier SC and detects an anomaly in the manufacturing system depending on the classification result. If an anomaly is detected, the processor P triggers an emergency action EA with an output C.

The clustering model CM and the sequence classifier SC can be implemented in accordance with the previous embodiments, or in other ways. For example, the clustering model CM can be implemented as an array containing learned parameters (e.g. Gaussian distributions) of each cluster. The sequence classifier SC can be implemented as an associative array data structure representing the behavior models. In case the behavior models are implemented as probabilistic finite-state machines, the associative array data structure stores their particular state transitions and their probabilities. The sequence classifier SC can also contain a threshold for the probability of state transitions. Based on that information, the processor P can detect an anomaly if the probability for at least one cluster transition in the live sequence is below that threshold.

In a modified embodiment that is depicted in FIG. 7, the analysis component AC also receives function block constraints FBC as a first input A. The function block constraints FBC are used for constraint-based clustering in the clustering model CM in the ways that have been described above.

For the actual deployment of the analysis component AC, at least three different embodiments are possible, depending on the application requirements, as shown in FIG. 8:

A first deployment scenario DS1 shows the analysis component in a big data cluster BDC. Its first input A and second input B are received from a distributed datastore DD. Its output C is fed into a streaming pipeline SP. A common distributed data-processing framework (e.g. Apache Hadoop/Spark) can be used for implementing the first deployment scenario DS1.

A second deployment scenario DS2 places the analysis component embedded in one or more data sources DS, for example in a Programmable Logic Controller PLC. The analysis component receives its first input A and second input B from the Programmable Logic Controller PLC and feeds its output C into the Programmable Logic Controller PLC as well, which is connected via a OPC unified architecture OPC UA to a MES/MOM backbone MB. Other data sources DS include a 3rd party application 3PA, which is connected via a connector CO to the MES/MOM backbone MB, and another Programmable Logic Controller PLC, which is connected via a Step 7 software S7 to the MES/MOM backbone MB. The second deployment scenario DS2 can be implemented using a programming API of an embedded controller (e.g. S7-1500).

A third deployment scenario DS3 places the analysis component next to the MES/MOM backbone MB. The analysis component receives its first input A from master data MD and its second input B from a Historian H that are located in the MES/MOM backbone MB. The analysis component feeds its output C into the MES/MOM backbone MB as well. Other components of the MES/MOM backbone MB include a visualization component V and an equipment model EM. All components of the MES/MOM backbone MB are connected via a messaging service MS. The third deployment scenario DS3 can be implemented using application development environments of common MES (e.g. Simatic IT).

An embodiment of the method provides an unsupervised and/or semi-supervised learning approach for process monitoring that is guided by control knowledge and that reduces complexity by local constraint propagation. As that algorithm requires additional control knowledge/constraints (e.g. derived from a function block implementation or alarm definition), usage can be detected based on the interface definition of the process monitoring box/implementation.

FIG. 9 shows a flowchart of an embodiment of the method for anomaly detection in a manufacturing system M. In a preparation phase PP, several time series datasets X₁, . . . , X_{N} are acquired from at least some, and in particular all, devices of the manufacturing system M, with each time series dataset X₁, . . . , X_{N} consisting of a number of instance vectors. A constraint-based clustering algorithm CBC assigns each instance vector of each time series dataset X₁, . . . , X_{N} to a cluster, thereby forming a sequence S of clusters for each time series dataset X₁, . . . , X_{N}. A learning algorithm builds at least one behavior model BM for the manufacturing system M by analyzing the sequences S.

In a monitoring phase MP, live instance vectors comprising data from at least some, and in particular all, devices of the manufacturing system M are acquired. The constraint-based clustering algorithm CBC assigns each live instance vector to a cluster, thereby forming a live sequence S_{L} of clusters. The live sequence S_{L} undergo a classification CL based on the at least one behavior model BM, resulting in a classification result CR. An anomaly is detected in the manufacturing system M depending on the classification result CR.

The method can be executed by a processor such as a microcontroller or a microprocessor, by an Application Specific Integrated Circuit (ASIC), by any kind of computer, including mobile computing devices such as tablet computers, smartphones or laptops, or by one or more servers in a control room or cloud.

For example, a processor, controller, or integrated circuit of the computer system and/or another processor may be configured to implement the acts described herein.

The above-described method may be implemented via a computer program product (non-transitory computer readable storage medium having instructions, which when executed by a processor, perform actions) including one or more computer-readable storage media having stored thereon instructions executable by one or more processors of a computing system. Execution of the instructions causes the computing system to perform operations corresponding with the acts of the method described above.

The instructions for implementing processes or methods described herein may be provided on non-transitory computer-readable storage media or memories, such as a cache, buffer, RAM, FLASH, removable media, hard drive, or other computer readable storage media. A processor performs or executes the instructions to train and/or apply a trained model for controlling a system. Computer readable storage media include various types of volatile and non-volatile storage media. The functions, acts, or tasks illustrated in the figures or described herein may be executed in response to one or more sets of instructions stored in or on computer readable storage media. The functions, acts or tasks may be independent of the particular type of instruction set, storage media, processor or processing strategy and may be performed by software, hardware, integrated circuits, firmware, micro code and the like, operating alone or in combination. Likewise, processing strategies may include multiprocessing, multitasking, parallel processing and the like.

The embodiments of the invention have been described in detail with reference to embodiments thereof and examples. Variations and modifications may, however, be effected within the spirit and scope of the embodiments of the invention covered by the claims. The phrase “at least one of A, B and C” as an alternative expression may provide that one or more of A, B and C may be used.

It is to be understood that the elements and features recited in the appended claims may be combined in different ways to produce new claims that likewise fall within the scope of the present embodiments of the invention. Thus, whereas the dependent claims appended below depend from only a single independent or dependent claim, it is to be understood that these dependent claims may, alternatively, be made to depend in the alternative from any preceding or following claim, whether independent or dependent, and that such new combinations are to be understood as forming a part of the present specification.

Although the invention has been illustrated and described in greater detail with reference to the preferred exemplary embodiment, the invention is not limited to the examples disclosed, and further variations can be inferred by a person skilled in the art, without departing from the scope of protection of the invention.

For the sake of clarity, it is to be understood that the use of “a” or “an” throughout this application does not exclude a plurality, and “comprising” does not exclude other steps or elements.

1. A method for anomaly detection in a manufacturing system, with one or more processors executing the following steps during a monitoring phase:
acquiring live instance vectors comprising data from at least some devices of the manufacturing system;
executing a constraint-based clustering algorithm to assign each live instance vector to a cluster, thereby forming a live sequence of clusters;
classifying the live sequence based on at least one behavior model; and
detecting an anomaly in the manufacturing system depending on a classification result.

2. The method according to claim 1, wherein the following steps are executed by one or more processors in a preparation phase prior to the monitoring phase:
acquiring several time series datasets from at least some devices of the manufacturing system, with each time series dataset consisting of a number of instance vectors;
executing a constraint-based clustering algorithm to assign each instance vector of each time series dataset to a cluster, thereby forming a sequence of clusters for each time series dataset; and
executing a learning algorithm to build the at least one behavior model for the manufacturing system by analyzing the sequences.

3. The method according to claim 2, wherein the learning algorithm builds a behavior model for each operation performed by the manufacturing system.

4. The method according to claim 2, wherein each time series dataset has a product state that was the result of a production cycle that is represented by the respective time series dataset, and wherein a cannot-link constraint is created for a pair of instance vectors if the pair share a same time step and respective time series datasets have different labels.

5. The system according to claim 4, wherein at least one of the behavior models is linked to at least one product state by mapping different clusters inside the behavior model to different product states, and wherein the live sequence is classified based on the at least one behavior model with respect to the product state.

6. The method according to claim 1, wherein:
with a behavior model for each operation performed by the manufacturing system, and
with each behavior model containing one or more clusters.

7. The method according to claim 1, wherein each of the at least one behavior models is a probabilistic finite-state automaton for which each cluster is considered as a state, and wherein an anomaly is detected if the probability for at least one cluster transition in the live sequence is below a learned or user-defined threshold in the respective behavior model.

8. The method according to claim 1, wherein the constraint-based clustering algorithm uses must-link constraints and/or cannot-link constraints.

9. The method according to claim 8, wherein prior to the monitoring phase, the must-link constraints and/or cannot-link constraints are derived from control knowledge about the manufacturing system.

10. The method according to claim 8, wherein prior to the monitoring phase, the must-link constraints and/or cannot-link constraints are extracted from specifications of function blocks of the manufacturing system, from input variables and/or output variables of function blocks in control code of PLCs.

11. The method according to claim 1, wherein an emergency action is triggered if an anomaly in the manufacturing system is detected.

12. The method according to claim 1, wherein prior to the monitoring phase, constraints are propagated inside equipment hierarchies.

13. The method according to claim 1, wherein the manufacturing system is a multi-operation manufacturing system.

14. A System for anomaly detection in a manufacturing system, comprising:
an interface configured to receive live instance vectors comprising data from at least some devices of the manufacturing system;
a memory containing a clustering model and a sequence classifier; and
a processor programmed for:
executing a constraint-based clustering algorithm to assign each live instance vector to a cluster of the clustering model, thereby forming a live sequence of clusters,
classifying the live sequence using the sequence classifier, and detecting an anomaly in the manufacturing system depending on the classification result.

15. The system according to claim 14, wherein the interface is configured to receive function block constraints, wherein the constraint-based clustering algorithm is configured to use the function block constraints, and wherein the system triggers an emergency action by generating an output when detecting the anomaly.

16. The system according to claim 14, wherein the function block constraints are must-link constraints and/or cannot-link constraints.

17. The system according to claim 16, wherein the function block constraints have been extracted from specifications of function blocks of the manufacturing system, from input variables and/or output variables of function blocks in control code of PLCs.

18. The system according to claim 14, wherein the sequence classifier contains a behavior model for each operation performed by the manufacturing system.

19. The system according to claim 18, wherein each behavior model is a probabilistic finite-state automaton for which each cluster is considered as a state, and wherein an anomaly is detected if the probability for at least one cluster transition in the live sequence is below a learned or user-defined threshold in the respective behavior model.

20. The system according to claim 14,
distributed over several data processing systems.

21. The system according to claim 14, wherein the system is deployed in a cloud.

22. The system according to claim 14, wherein the system is embedded in a controller.

23. The system according to claim 14, wherein the system is deployed in a manufacturing execution system.

24. A computer-readable storage media having stored thereon:
instructions executable by one or more processors of a computer system, wherein execution of the instructions causes the computer system to perform the method according to claim 1.

25. A computer program product, (non-transitory computer readable storage medium having instructions, which when executed by a processor, perform actions)
which is being executed by one or more processors of a computer system and performs the method according to claim 1.
